(19) United States
(12) Patent Application Publication
(10) Pub. No.: US 2013/0211614 A1
(43) Pub. Date: Aug. 15, 2013

(54) APPARATUS AND METHOD FOR CONTROLLING SMART APPLIANCE USING SMART TERMINAL

(71) Applicant: Electronics and Telecommunications Research Institute, (US)

(72) Inventor: Moon Ok CHOI, Chungcheongbuk-do (KR)

(73) Assignee: Electronics and Telecommunications Research Institute, Daejeon (KR)

(21) Appl. No.: 13/755,838

(22) Filed: Jan. 31, 2013

(30) Foreign Application Priority Data
Feb. 9, 2012 (KR) 10-2012-0013103

(51) Int. Cl. G05B 13/02

(52) U.S. Cl. CPC G05B 13/02
USPC 700/295

(57) ABSTRACT

Provided is an apparatus and method for controlling a smart appliance using a smart terminal to induce a user to reduce energy consumption in response to a demand response signal from an energy utility. The apparatus and method may motivate a user to reduce energy consumption effectively and actively in response to the demand response signal from the energy utility by allowing the user to report a demand response-based user-defined event to a pre-registered smart terminal, and to control a user-premises smart appliance using the smart terminal.

### CROSS-REFERENCE TO RELATED APPLICATION

This application claims the priority benefit of Korean Patent Application No. 10-2012-0013103, filed on Feb. 9, 2012, in the Korean Intellectual Property Office, the disclosure of which is incorporated herein by reference.

### BACKGROUND

1. Field of the Invention

Exemplary embodiments relate to an apparatus and method for controlling a smart appliance using a smart terminal to induce a consumer to reduce energy consumption in response to a demand response signal from an energy utility.

2. Description of the Related Art

Energy saving technologies are being developed in an effort to promote an energy saving mode of individual electronic products. Currently, energy saving technologies are based on a demand response mechanism for operating a smart product in an energy saving mode at peak times and in a normal mode at off-peak times, based on demand response information, in particular, price information.

However, these passive energy saving technologies fail to respond to an abrupt increase in demand due to a transmission failure of price information in real time which makes it difficult to achieve high energy saving effects. To resolve this issue, a direct energy control technology or a dynamic energy control technology has been proposed to allow a consumer to control a function provided by a smart appliance including an ON/OFF function within an allowable range using a smart terminal. This may maximize a real-time response to a peak demand to deal with unexpected situations, such as, for example, an electrical outrage or a blackout, that is, a large-scale power failure, as well as to improve energy saving effects.

A smart grid corresponds to a form of an electric grid network using a digital technology to support an energy production and distribution system for optimum energy efficiency. Recently, a smart grid has been gaining attention globally, and many governments are adopting and enacting smart grid policies.

Demand response is a key smart grid application for motivating a consumer to reduce energy usage or offer incentives at times of higher wholesale electricity price or during periods of low operational systems reliability.

Leading global manufacturers, for example, GE, Whirlpool, LG, and the like, have developed and manufactured smart appliances having a smart grid-related function.

Conventional demand response technologies are implemented to induce a consumer to operate an appliance directly at times of relatively lower price based on energy price information published through via the Internet, or to allow a consumer to operate an appliance directly at times of relatively lower price using an ON/OFF timer function mounted in a display device of the appliance based on time-based price information displayed on the display device.

In demand response, a direct load control for a smart appliance may be enabled by an energy utility and the like. However, according to smart appliance market research, most consumers are unwilling to expose personal information including user-location appliance information for direct load control, and prefer utilizing independent-control for an appliance.

### SUMMARY

An aspect of the present invention provides an apparatus and method for controlling a smart appliance using a smart terminal to motivate a user to reduce energy consumption effectively and actively in response to a demand response signal from an energy utility by allowing the user to report a demand response-based user-defined event to a pre-registered smart terminal, and to operate a user-defined pre-registered control program with the smart terminal or to control an energy-related function of each smart appliance, for example, an ON/OFF function, an energy saving function, and the like, using the smart terminal.

According to an aspect of the present invention, there is provided an apparatus for controlling a smart appliance using a smart terminal, the apparatus including an event registering unit to define and register a price event, an event generating unit to report a price event corresponding to a demand response signal to a smart terminal when the demand response signal is received from an energy utility, and an energy control unit to control energy consumption of a smart appliance based on a control signal received from the smart terminal.

According to another aspect of the present invention, there is provided a method of controlling a smart appliance using a smart terminal, the method including defining and registering a price event, reporting a price event corresponding to a demand response signal to a smart terminal when the demand response signal is received from an energy utility, and controlling energy consumption of a smart appliance based on a control signal received from the smart terminal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network structure of an apparatus for controlling a smart appliance using a smart terminal according to an embodiment of the present invention;

FIG. 2 is a block diagram illustrating a smart energy gateway and a smart terminal according to an embodiment of the present invention; and

FIG. 3 is a flowchart illustrating a method of controlling a smart appliance using a smart terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, an apparatus and method for controlling a smart appliance using a smart terminal according to an embodiment of the present invention is described.

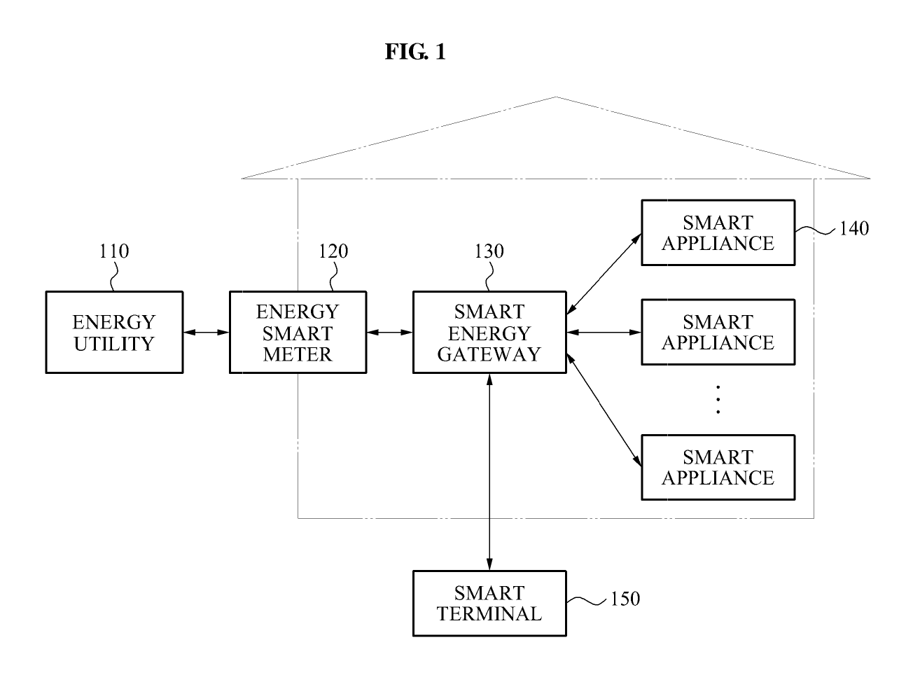

FIG. 1 is a diagram illustrating a network structure of an apparatus for controlling a smart appliance using a smart terminal according to an embodiment of the present invention.

Referring to FIG. 1, the apparatus may include an energy utility 110, an energy smart meter 120, a smart energy gateway 130, at least one smart appliance 140, and a smart terminal 150.

The energy utility 110 may be connected with the user-side energy smart meter 120 via an advanced metering infrastructure (AMI) network. A demand response signal from the energy utility 110 may be transmitted to the smart energy gateway 130 through the energy smart meter 120. In this instance, the demand response signal may include at least one of time-based price information, system reliability information, and demand response information.

The demand response signal received through the energy smart meter 120 may be transmitted to the smart energy gateway 130 connected with the user-premises smart appliances 140 via wired or wireless communication, for example, Zigbee communication.

The smart energy gateway 130 may determine whether to generate an event based on the input demand response signal, and may transmit the generated event to the smart terminal 150 of the user.

The user may identify the demand response-based event received through the smart terminal 150, and may control energy consumption for each of the smart appliances 140, or may control energy consumption for all of the smart appliances 140 by selecting a pre-defined control program.

The selected control program may be transmitted to the smart energy gateway 130, and the smart energy gateway 130 may control energy consumption of the smart appliance 140 based on the selected control program.

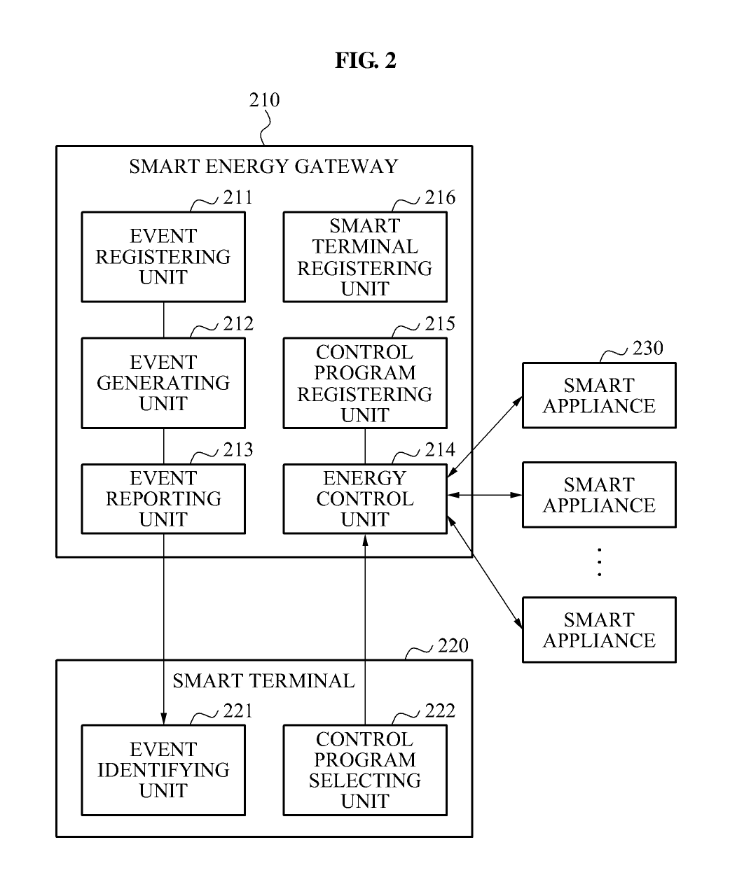

FIG. 2 is a block diagram illustrating a smart energy gateway 210 and a smart terminal 220 according to an embodiment of the present invention.

Referring to FIG. 2, the smart energy gateway 210 may include an event registering unit 211, an event generating unit 212, an event reporting unit 213, an energy control unit 214, a control program registering unit 215, and a smart terminal registering unit 216. The smart terminal 220 may include an event identifying unit 221 and a control program selecting unit 222.

The smart terminal registering unit 216 may register, in the smart energy gateway 210, the smart terminal 220 to allow energy control. The smart terminal registering unit 216 may authorize the registered smart terminal 220 to control energy consumption.

The event registering unit 211 may allow a user to define and register a price event. In this instance, the price event generated based on a demand response signal from an energy utility may be defined to be a time at which the price is greater than or less than a predetermined price, or when a peak price is applied.

When the demand response signal is received from the energy utility, the event generating unit 212 may analyze the received demand response signal, and may generate a price event corresponding to the analysis result. The event generating unit 212 may generate a price event at a predetermined time interval set by an internal timer based on user-defined characteristics of the price event.

The event reporting unit 213 may transmit the generated price event to the smart terminal 220. Also, the event reporting unit 213 may receive notification of reception of the price event from the smart terminal 220.

The control program registering unit 215 may register a control program defining a control flow and a control method for all user-location smart appliances, and when a predetermined program is selected through the smart terminal 220, may control the smart appliance 230 based on the flow and method defined in the corresponding program.

The energy control unit 214 may receive selection of a control program from the smart terminal 220, and may control energy consumption of the smart appliance 230 based on the selected control program.

As described in the foregoing, the smart terminal 220 registered in the smart energy gateway 210 may include the event identifying unit 221 and the control program selecting unit 222. Functions of the smart terminal 220 may be implemented as an application for a smart device.

The event identifying unit 221 may receive the price event from the smart energy gateway 210, and may output the received price event through a display. The user may identify the price event through the display.

The control program selecting unit 222 may output the control program through a selection interface, may receive selection of the control program by the user, and may transmit the selected control program to the smart energy gateway 210. The smart energy gateway 210 may control energy consumption of the smart appliance 230 based on the selected control program.

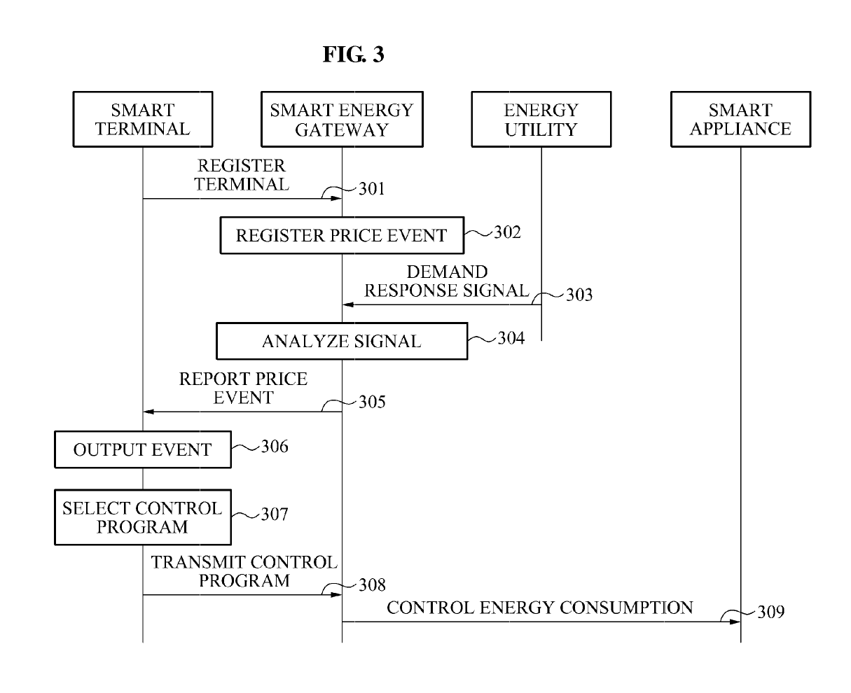

FIG. 3 is a flowchart illustrating a method of controlling the smart appliance using the smart terminal according to an embodiment of the present invention.

Referring to FIG. 3, in operation 301, the smart energy gateway may register a smart terminal to allow energy control. The smart energy gateway may authorize the registered smart terminal to control energy consumption.

In operation 302, the smart energy gateway may define and register a price event. The smart energy gateway may define the price event to be at least one of a time at which the price is greater than or less than a predetermined price, or a time when a peak price is applied.

When the smart energy gateway receives a demand response signal from the energy utility in operation 303, the smart energy gateway may analyze the received demand response signal in operation 304, and may report a price event corresponding to the demand response signal to the smart terminal in operation 305.

The smart energy gateway may analyze the demand response signal to determine at least one of time-based price information, system reliability information, and demand response information, and may generate a price event corresponding to the determined result.

The smart energy gateway may report the price event to the smart terminal. For example, the smart energy gateway may report the price event to the smart terminal at a predetermined time interval.

In operation 306, the smart terminal may receive the price event from the smart energy gateway and may output the received price event through a display. The user may identify the price event through the display.

In operation 307, the smart terminal may output a control program through a selection interface, may receive selection of the control program by the user, and in operation 308, may transmit the selected control program to the smart energy gateway.

In operation 309, the smart energy gateway may control energy consumption of the smart appliance based on the control program received from the smart terminal. The smart energy gateway may control the smart appliance based on a control flow and a control method for the smart appliance selected by the control program.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments, the present invention may allow a user to generate a user-defined event in response to a demand response signal, to report the event to a smart terminal, and to control a user-premises smart appliance using the smart terminal, to induce the user to reduce energy consumption effectively and actively.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling a smart appliance using a smart terminal, the apparatus comprising:
an event registering unit to define and register a price event;
an event generating unit to report a price event corresponding to a demand response signal to a smart terminal when the demand response signal is received from an energy utility; and
an energy control unit to control energy consumption of a smart appliance based on a control signal received from the smart terminal.

2. The apparatus of claim 1, wherein the event registering unit defines the price event to be a time when the price is greater than or less than a predetermined price or when a peak price is applied.

3. The apparatus of claim 1, wherein the event generating unit comprises:
a signal analyzing unit to analyze the demand response signal to determine at least one of time-based price information, system reliability information, and demand response information, and to generate the price event corresponding to the analysis result; and
an event reporting unit to report the price event to the smart terminal.

4. The apparatus of claim 1, wherein the energy control unit comprises:
a control program registering unit to control energy consumption of the smart appliance selected by the control signal, based on a control flow and a control method for the selected smart appliance.

5. A method of controlling a smart appliance using a smart terminal, the method comprising:
defining and registering a price event;
reporting a price event corresponding to a demand response signal to a smart terminal when the demand response signal is received from an energy utility; and
controlling energy consumption of a smart appliance based on a control signal received from the smart terminal.

6. The method of claim 5, wherein the registering comprises defining the price event to be a time when the price is greater than or less than a predetermined price or when a peak price is applied.

7. The method of claim 5, wherein the reporting comprises:
analyzing the demand response signal to determine at least one of time-based price information, system reliability information, and demand response information, and generating the price event corresponding to the analysis result; and
reporting the price event to the smart terminal.

8. The method of claim 5, wherein the controlling comprises:
controlling energy consumption of the smart appliance selected by the control signal, based on a control flow and a control method for the selected smart appliance.
